(19) United States
(12) Patent Application Publication
(10) Pub. No.: US 2020/0119635 A1
(43) Pub. Date: Apr. 16, 2020

(54) RESONANT SWITCHED CAPACITOR DC/DC CONVERTER

(71) Applicant: Amir Rahimi, Mission Viejo, CA (US)

(72) Inventor: Amir Rahimi, Mission Viejo, CA (US)

(21) Appl. No.: 16/157,471

(22) Filed: Oct. 11, 2018

(51) Int. Cl. H02M 3/07; H02M 1/08

(52) U.S. Cl. CPC H02M 3/07; H02M 2001/0048; H02M 1/08

(57) ABSTRACT

This disclosure is directed to devices and techniques DCDC power conversion. For example, this disclosure describes a DCDC converter that includes both a switched capacitor network and a resonance network. The described converter may be controlled to perform soft switching based on at least one characteristic of the switched capacitor network and/or the resonance network. According to one such example, a switching frequency and/or duty cycle used to control the described converter may be based on one or more of a capacitance value of at least one capacitor component of the capacitor network, and/or an inductance value of at least one inductor component of the resonance.

### FIELD

This disclosure is generally directed to power conversion and, more specifically, to systems, devices, and techniques for performing DCDC power conversion.

### BACKGROUND

Many applications require a stable power supply in a specified voltage range to function as intended. For example, a mobile device of a smartphone may include a battery with a relatively high voltage (e.g., 12 V), while a processor of the smartphone is designed to operate using a lower voltage level (e.g., 1V). Similarly, a power supply for a server rack may convert mains power (e.g., single-phase 120V or three-phase 208V or higher in the United States) from a power grid into a relatively high DC source voltage, while a processor of the server rack may operate at lower voltage level (e.g., ˜1V).

Many electronic devices and systems use a DCDC converter to convert a source voltage at a first DC voltage level to a supply voltage for one or more components at a second DC voltage level different than the source voltage. In some examples, a DCDC converter is a step-down converter that converts a source voltage at a higher first DC voltage level to a supply voltage at a second DC voltage level lower than the first DC voltage level. In other examples, a DC/DC converter is a step-up converter that converts a source voltage at a lower first DC voltage level to a supply voltage at a higher second DC voltage level.

In recent years, reducing power consumption in electronic devices and systems has become increasingly important. Since DCDC converters are frequently employed in many electronics, a need exist for improvements in various aspects of DCDC converters such as conversion efficiency, size, and cost of the converters.

### SUMMARY

This disclosure is directed to DCDC power converters and techniques for operating DCDC power converters. A resonant switched capacitor DCDC converter is described herein which operates with high efficiency in comparison with traditional DCDC converters.

As one example, a DCDC converter is described herein. The DCDC converter includes an input, an output, and a capacitor network. The DCDC converter further includes a resonance network coupled to the capacitor network. The DCDC converter further includes at least one controller operable to control the DCDC converter to perform soft switching based on at least one characteristic of the resonance network and/or the capacitor network.

As another example, a method is described herein. The method includes receiving, at an input of a DCDC converter, input power at a first voltage level. The method further includes operating the DCDC converter based on at least one characteristic of a resonance network of the DCDC converter and/or a capacitor network of the DCDC converter, to perform soft switching. The method further includes outputting, based on the operating, output power at a second voltage level different than the first voltage level.

As another example, a DCDC converter is described herein. The DCDC converter includes an input, an output, and a switched capacitor network. The DCDC converter further includes a resonance network coupled to the switched capacitor network. The DCDC converter further includes means for controlling the DCDC converter to perform soft switching based on at least one characteristic of the resonance network and/or the switched capacitor network.

### BRIEF DESCRIPTION OF THE DRAWINGS

FIG. 1 is a block diagram depicting one example of a resonant switched capacitor DCDC power converter consistent with one or more aspects of this disclosure.

FIG. 2 is a circuit diagram depicting one example of a converter with a conversion factor N=2 consistent with one or more aspects of this disclosure.

FIG. 3 is a graphical diagram depicting operation of a converter with a conversion factor N=2 consistent as described herein, consistent with one or more aspects of this disclosure.

FIG. 4 is a circuit diagram depicting one example of a converter with a conversion factor N=3 consistent with one or more aspects of this disclosure.

FIG. 5 is a graphical diagram depicting operation of a converter with a conversion factor N=3 as described herein, consistent with one or more aspects of this disclosure.

FIG. 6 is a circuit diagram depicting one example of a converter with a conversion factor N=4 consistent with one or more aspects of this disclosure.

FIG. 7 is a is a graphical diagram depicting operation of a converter with a conversion factor N=4 as described herein, consistent with one or more aspects of this disclosure.

FIG. 8 is a circuit diagram depicting one example of a converter with a conversion factor N=2 consistent with one or more aspects of this disclosure.

FIG. 9 is a circuit diagram depicting one example of a converter with a conversion factor N=2 consistent with one or more aspects of this disclosure.

FIG. 10 is a circuit diagram depicting one example of a converter with a conversion factor N=3 consistent with one or more aspects of this disclosure.

FIG. 11 is a flow diagram depicting one example of a method of operating a DCDC power converter consistent with one or more aspects of this disclosure.

FIGS. 12A and 12B are conceptual diagrams that depict a generic converter with a conversion ratio N consistent with one or more aspects of this disclosure.

FIGS. 13A-13D are circuit diagrams that depict various examples of converters with a resonance network that includes multiple inductive elements consistent with one or more aspects of this disclosure.

### DETAILED DESCRIPTION

This disclosure is directed to improvements in DCDC power converters. In particular, this disclosure is directed to circuits, and techniques for controlling those circuits, which provide for improvements in DCDC power converters such as power efficiency (i.e., how much energy is lost in the process of converting an input DC voltage to a different output DC voltage), size, and costs to manufacture DCDC power converters.

One typical example of a DCDC power converter is a switched capacitor network. A switched capacitor network typically includes a plurality of capacitors, a first switch (or switches), and a second switch (or switches). In operation, the first switch(s) and second switch(s) are turned on or off in an alternating pattern, thereby charging or discharging the capacitors such that an input voltage supplied to the switched capacitor network is converted into a desired output voltage.

To operate a traditional switched capacitor-based converter as described above, the converter is typically controlled with a predetermined and/or fixed switching frequency and/or duty cycle. For example, a traditional switched capacitor-based converter may be controlled to switch at a switching frequency based on the particular application. As another example, a traditional switched capacitor-based converter may be controlled with a predetermined duty cycle such as a 50 percent duty cycle.

This disclosure is directed to electrical circuits for performing DCDC power conversion, including DCDC converters that include a switched capacitor network and resonance network, as well as techniques for controlling such converters.

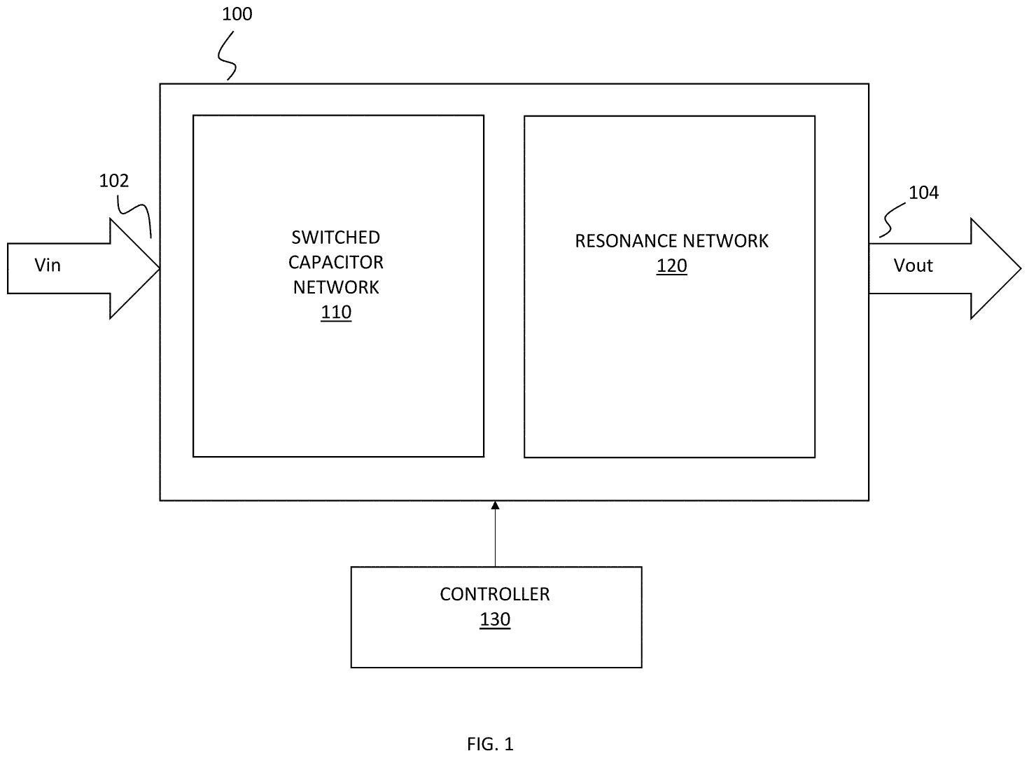

FIG. 1 is a conceptual block diagram that depicts one example of a resonant switched capacitor DCDC converter 100 consistent with one or more aspects of this disclosure. As shown in FIG. 1, converter 100 is adapted to receive an input voltage Vᵢₙ 102 with a first DC voltage level, and convert it into an output voltage Vₒᵤₜ 104 at a second voltage level different than the first voltage level. Converter 100 may be operated as a step-up converter, where the output voltage Vₒᵤₜ 104 is greater than the input voltage Vᵢₙ 102, or as a step-down converter, where the output voltage Vₒᵤₜ 104 is less than the input voltage Vᵢₙ 102.

As shown in FIG. 1, converter 100 includes a capacitor network 110 and a resonance network 120. Switched capacitor network 110 includes one or more capacitors (not shown in FIG. 1), a first plurality of switches (also not shown in FIG. 1), and a second plurality of switches (also not shown in FIG. 1). Capacitor network 110 operates coupled to resonance network 120. Resonance network 120 includes one or more inductive components (not shown in FIG. 1) that comprise any device or circuit element with a measurable inductance, such as an inductor component.

Converter 100 depicted in FIG. 1 may be configured to convert an input voltage Vᵢₙ to an output voltage Vₒᵤₜ (or vice versa), with a desired conversion ratio N. For example, when configured with a conversion ratio N=2, the converter will convert an input voltage Vᵢₙ of 24 volts to an output voltage Vₒᵤₜ of 12 volts. As another example when configured with a conversion ration N=4, the converter will convert an input voltage Vin of 48 volts to an output voltage Vₒᵤₜ of 12 volts.

The number N corresponds to a number of fly capacitors C_{fly} (not depicted in FIG. 1) used in converter 100, where N=the number of fly capacitors C_{fly}+1. For example, converter 100 configured as a N=2 converter converts an input voltage Vᵢₙ into an output voltage Vₒᵤₜ with a voltage level of half Vᵢₙ may include a single fly capacitor C_{fly}. As another example, converter 100 configured as a N=3 converter converts an input voltage Vᵢₙ into an output voltage Vₒᵤₜ with a voltage level of one third of Vᵢₙ may include two fly capacitors C_{fly}. As another example, converter 100 configured as a N=4 converter converts an input voltage Vᵢₙ into an output voltage Vₒᵤₜ with a voltage level of one quarter of Vᵢₙ may include three fly capacitors C_{fly}.

As shown in FIG. 1, converter 100 is controlled by a controller 130. Controller 130 controls converter 100 based on one or more characteristics of capacitor network 100 and/or resonance network 120. Controller 130 includes any combination of hardware or software suitable to generate pulses to operate controller 130. For example, controller 130 may include a a microcontroller executing program instructions to control converter 100, or any other device capable of controlling converter by generating pulses at a desired switching frequency and/or duty cycle. As one non-limiting example, controller 120 may be a timer-IC such as “555” that generates a pulse train with designated switching-frequency and/or duty-cycle. In some examples, controller 130 is an integrated device that includes integrated controller and driver portions that generate control signals and drive switches of converter 100. In other examples, controller 130 may include a discrete controller and driver devices.

As described above, capacitor network of converter 100 includes a first group of switches and a second group of switches. The first and second groups of switches each include switches suitable to operate as power switches for purposes of power conversion. For example, the respective switches of converter 100 may include silicon-based metal oxide semiconductor field effect transistors (MOSFET), bipolar junction transistors (BJT), junction gate field effect (JFET) transistors, insulated gate bipolar transistors (IGBT), or Gallium Nitride or silicon carbide-based power transistors.

According to the techniques described herein, controller 130 controls converter 100 with a duty cycle and switching frequency for driving converter 100 based on one or more characteristics of capacitor network 110 (e.g., a capacitance value of the capacitor(s)), and/or resonance network 120 (e.g., an inductance of an inductive component of resonance network 120).

In some examples, by controlling converter 100 as described herein, converter 100 performs soft switching (e.g., zero current switching (ZCS)), by switching the respective switches of the capacitor network when a current through the switches is zero or close to zero, thereby resulting in improved efficiency in comparison with other DCDC power converter designs. In addition, one or more inductor components of resonance network 120 may be relatively small in comparison with other power converters, which may be beneficial in the design of converter 100, as well as reduced cost in comparison to other types of converters.

As described above, converter 100 is controllable based on at least one characteristic of capacitor network 110 and/or resonance network 120. For example, converter 100 may be controllable (e.g., a duty cycle and or switching frequency) based on a capacitance value of at least one capacitor component of capacitor network 110, and/or an inductance value of at least one inductor component of resonance network 120. In some examples, controller 130 determines how to control converter 100 based on existing values associated with capacitor network 110 and/or resonance network 120.

In other examples, it may be desirable for converter 100 to operate at a predetermined switching frequency and/or duty cycle, such as when desirable for a particular application for converter. For example, it may be desirable for converter 100 to operate at a desired switching frequency to avoid interference with other components of a device or system (as a specific example, to avoid undesirable audible noise that may be heard by a consumer). According to these examples, converter 100 may be specifically designed to operate at a desired switching frequency or duty cycle, by selecting respective inductor (e.g., inductance level) or capacitor (capacitance level) components of capacitor network 110 and/or resonance network 120, in order to achieve efficient operation at the desired switching frequency or duty cycle.

According to the techniques of this disclosure, controller 130 operates differently to control converter 100 in comparison to a traditional switched capacitor-based converter as described above. For example, instead of using a predetermined switching frequency, controller 130 determines a switching frequency for converter 100 based on one or more characteristics of capacitor network 110 and/or resonance network 120, such as an inductance value of an inductor component of resonance network 120 and/or a capacitance value of one or more capacitors of capacitor network 120. In addition, instead of using a predetermined duty cycle of, for example, 50% as is used in a traditional switched capacitor-based converter, controller 130 determines a duty cycle for converter 100 based on one or more characteristics of the capacitor network and/or the resonance network, for example a number of switches and/or a number of fly capacitors of capacitor network 110 (which may be based on the conversion ratio of converter 100).

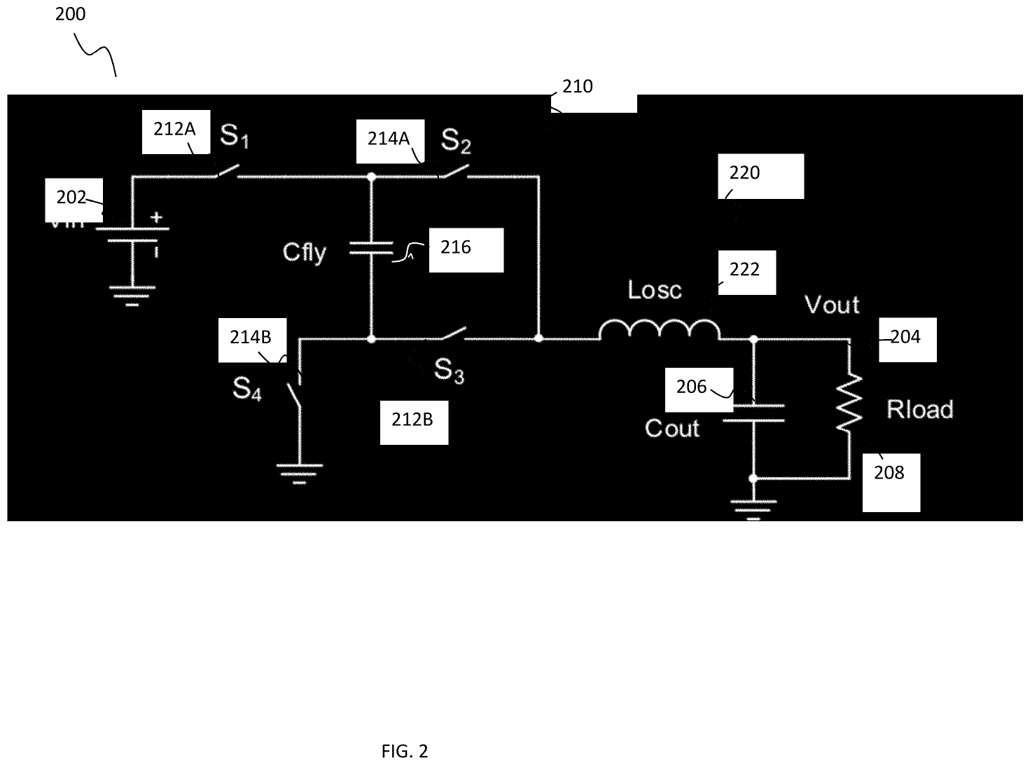

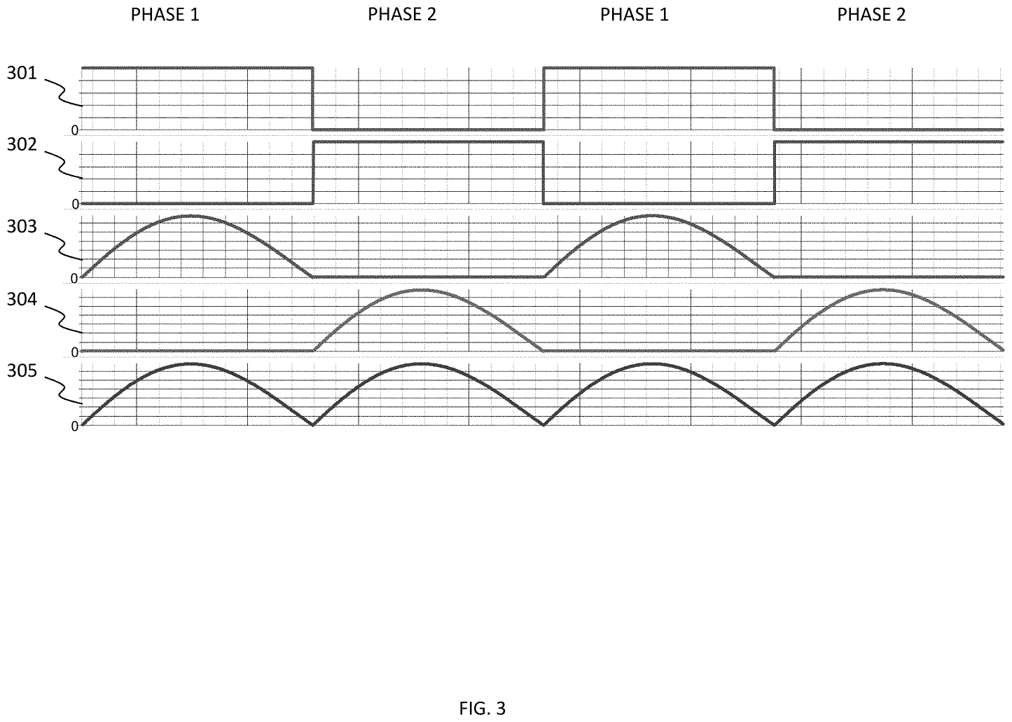

FIG. 2 is a circuit diagram depicting one example of a converter 200 with a conversion ratio N=2 consistent with one or more aspects of this disclosure. FIG. 3 is a graphical diagram including plots depicting converter 200 in operation consistent with one or more aspects of this disclosure.

In the example depicted in FIG. 2, converter 200 includes an input Vᵢₙ 202 and an output Vₒᵤₜ 204. In the depicted example, converter 200 is a step-down converter configured to receive a higher DC voltage level at input Vᵢₙ 202, and convert it to a lower DC voltage level (e.g., Vᵢₙ/2) at output Vₒᵤₜ 204. In other examples not depicted in FIG. 2, converter 200 is configurable as a step-up converter by coupling lower input voltage to Vₒᵤₜ 204, to convert it to a higher output voltage at Vᵢₙ 202.

In the example of FIG. 2, converter 200 includes an output capacitor component Cₒᵤₜ 206 coupled to output Vₒᵤₜ 204, and a load resistance R_{load} 208 coupled to output Vₒᵤₜ 204. The load resistance R_{load} represents a resistance of a load to be powered by converter 200, such as an electronic component that operates with a supply voltage of Vₒᵤₜ.

As shown in FIG. 2, converter 200 includes a capacitor network 210 and a resonance network 220. Capacitor network 210 includes at least one capacitor C_{fly} 216, a first group of switches (S1, S3) 212A, 212B, and a second group of switches (S2, S4) 214A, 214B. Resonance network 220 includes an inductor component 222 coupled between capacitor network 210 and output Vₒᵤₜ 204.

Converter 200 is controllable via the first group of switches 212A, 212B, and the second group of switches 214A, 214B. For example, a controller 130 (not depicted in FIG. 2) may drive switches 212A, 212B in an alternating fashion with switches 214A, 214B, such that when switches 212A, 212B are closed, switches 214A, 214B are open, and vice versa.

Plot 301 of FIG. 3 depicts switching behavior of first switches 212A, 212B (such that when the signal shown in the plot 301 is at a high voltage level, the first switches, 212A and 212B, are on), while plot 302 depicts switching behavior of second switches 214A, 214B. As shown in plots 301 and 302, during a first phrase of converter 200, switches 212A (S1) and 212B (S3) are closed and switches 214A (S2) and 214B (S4) are open, causing energy to be transferred from input source, Vin (202) to capacitor C_{fly} 216 and capacitor Cₒᵤₜ 206 (and output Vₒᵤₜ). During the first phase of converter 200, capacitor C_{fly} 216 may be described as connected in series with output capacitor Cₒᵤₜ 206.

As also shown in plots 301 and 302, during a second phrase of converter 200, switches 212A (S1) and 212B (S3) are opened and switches 214A (S2) and 214B (S4) are closed, causing energy to be transferred from capacitor C_{fly} 216 to Cout (206). During the second phrase of converter 200, capacitor C_{fly} 216 may be described as connected in parallel with output capacitor Cₒᵤₜ 206.

According to converter 200 described herein, resonance network 220 introduces a resonance with which converter 200 may be operated to perform soft switching, thereby improving an efficiency of converter 200. Plot 303 shows the current through first switches 212A, 212B, plot 304 shows current through second switches 214A, 214B, while plot 305 shows current through inductor L_{osc}. As shown in plot 305, as converter 200 is operated to alternatingly switch between first switches 212A, 212B and second switches 214A, 214B, a current through inductor component Losc 222 periodically rises and falls with each switching cycle. According to the techniques herein, as shown in plots 303 and 304, first and second switches 212A-212B and 214A-214B are operated in accordance with the resonant behavior of inductor Losc 222 and/or capacitor(s) Cfly 216 such that the first switches 212A-212B are closed (and second switches 214A-214B are opened) when a current through second switches 214A-214B is zero or close to zero. Likewise, second switches 214A-214B are closed (and first switches 212A-212B are opened) when a current through first switches 212A-212B is zero or close to zero.

In some examples, in order to achieve soft switching as described herein, converter 200 is controlled based on one or more characteristics of fly capacitor C_{fly} 216 and/or inductor component L_{osc} 222. For example, a controller 120 (not shown in FIG. 2), may control switches 212A-212B and 214A-214B with a switching frequency (frequency at which switches 212A-212B and 214A-214B are alternately switched on and off) and/or a duty cycle (ratio representing how long converter 200 is operated in the first phrase, or the second phrase as described above) based on a capacitance value of fly capacitor C_{fly}, and/or an inductance of inductor component L_{osc} 222.

As one example, controller 120 may control converter 200 with a switching frequency F_{sw} according to the following equation:

$$Fsw = \frac{1}{N \times π \times \sqrt{\frac{Cfly \times Losc}{N - 1}}} \qquad ( 1 )$$

Where N=2 according to the conversion ratio of converter 200. As shown in the above equation, a switching frequency F_{sw} is determined based on an inductance of inductor component L_{osc} 208, a capacitance of fly capacitor C_{fly} 206, and the conversion ratio N of controller 200 (N=2).

Controller 120 may also control a duty cycle of converter 200 according to equation (2) below, where duty cycle is the ratio of the time that first switches 212A-212B (S1, S3) are on during a switching period T (T=1/F_{sw}):

$$Duty Cycle = \frac{Ton ( S 1 , S 3 )}{T ( = 1 / Fsw )} = \frac{1}{N} \qquad ( 2 )$$

Operating converter 200 to perform soft switching (e.g., zero current switching) as described herein may cause less energy to be lost as a result of opening or closing the respective switches. Accordingly, converter 200 may perform with higher efficiency than other types of converters.

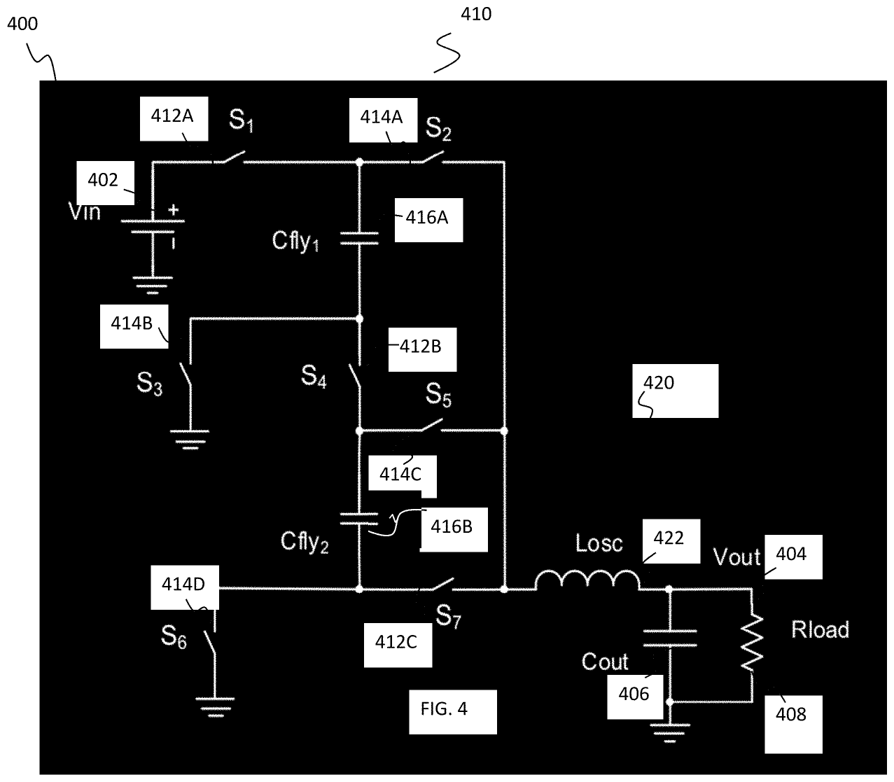

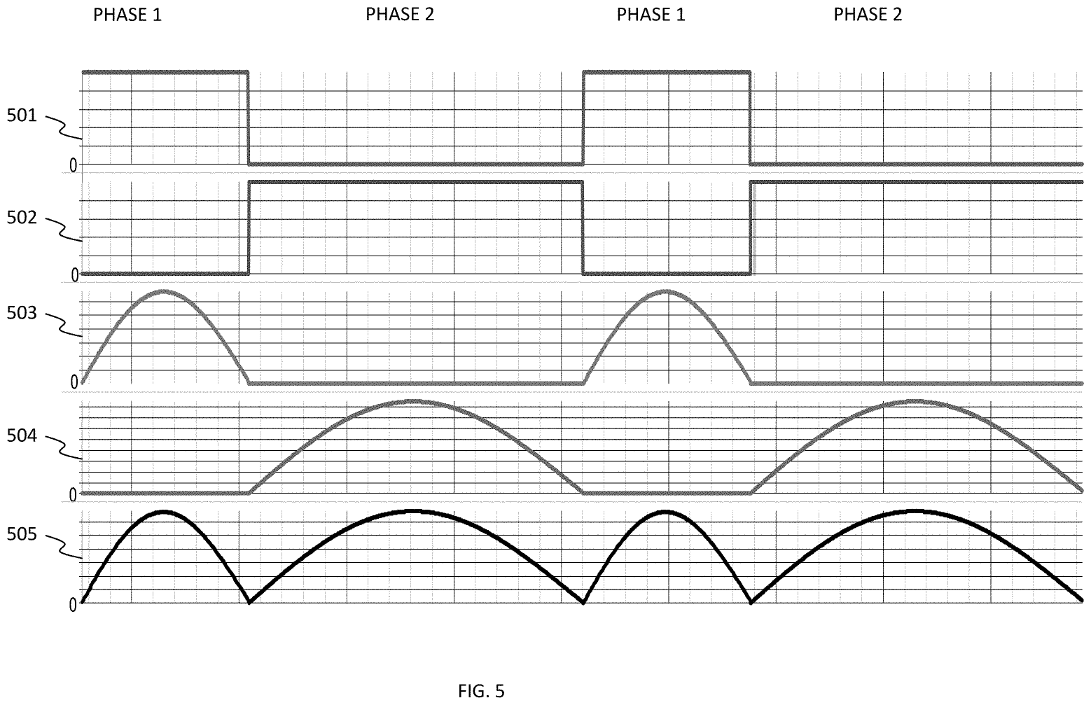

FIG. 4 is a circuit diagram that depicts one example of a resonant switched capacitor converter 400 with a conversion ratio of N=3 consistent with one or more aspects of this disclosure. FIG. 5 is a graphical diagram including plots depicting converter 400 in operation consistent with one or more aspects of this disclosure.

In the example depicted in FIG. 4, converter 400 includes an input Vᵢₙ 402 and an output Vₒᵤₜ 404. In the depicted example, converter 400 is a step-down converter configured to receive a higher DC voltage level at input Vᵢₙ 402, and convert it to a lower DC voltage level (e.g., Vᵢₙ/3) at output Vₒᵤₜ 204. In other examples not depicted in FIG. 4, converter 400 is configurable as a step-up converter by coupling an input voltage to Vₒᵤₜ 404, to convert it to a higher output voltage at Vᵢₙ 402.

In the example of FIG. 4, converter 400 includes an output capacitor Cₒᵤₜ 406 coupled to output Vₒᵤₜ 404, and a load resistance R_{load} 408 coupled to output Vₒᵤₜ 404. The load resistance R_{load} represents a resistance of a load to be powered by converter 400, such as an electronic component.

As shown in FIG. 4, converter 400 includes a capacitor network 410 and a resonance network 420. Capacitor network 410 includes at least one capacitor (first capacitor C_{fly1} 416A, second capacitor C_{fly2} 416B) a first group of switches (S1, S4, S7) 412A-412C, and a second group of switches (S2, S3, S5, S6) 414A-414D. Resonance network 420 includes an inductor component L_{osc} 422 coupled between capacitor network 410 and output Vₒᵤₜ 404. In some examples, capacitors C_{fly1} 416A, C_{fly2} 416B may be substantially similar. For example, capacitors C_{fly1} 416A, C_{fly2} 416B may have substantially similar capacitance values.

Converter 400 is controllable via the first group of switches 412A-412C, and the second group of switches 414A-414D. For example, a controller 130 (not depicted in FIG. 4) may drive first switches 412A-412C in an alternating fashion with second switches 414A-414D, such that when first switches 412A-412C are closed, second switches 414A-414D are open, and vice versa.

Plot 501 of FIG. 5 depicts switching behavior of first switches 412A-412C, while plot 502 depicts switching behavior of second switches 414A-414D during operation of converter 400. As shown in plots 501 and 502, during a first phase of converter 400, first switches 412A (S1), 412B (S4), and 412C (S7) are closed and second switches 414A (S2) 414B (S3), 414C (S5), and 414D (S6) are open, thereby transferring energy from input Vᵢₙ 402 to capacitors C_{fly1} 416A, C_{fly2} 416B and Cout 406, thereby charging capacitors 416A, 416B and 406. During the first phase of converter 400, capacitors 416A, 416B may be described as connected in series with output capacitor Cₒᵤₜ 406.

As also shown in plots 501 and 502, during a second phrase of converter 400, first switches 412A (S1), 412B (S4), and 412C (S7) are opened and second switches 414A (S2) 414B (S3), 414C (S5), and 414D (S6) are closed, causing charge stored in capacitors 416A, 416B to be discharged to output capacitor Cout 406. During the second phrase of converter 400, capacitors 416A, 416B may be described as connected in parallel with output capacitor Cₒᵤₜ 406.

According to converter 400 described herein, resonance network 420, in conjunction with capacitors of the capacitor network 410, introduces a resonance with which converter 400 may be operated to perform soft switching, thereby improving an efficiency of converter 400. Plot 503 of FIG. 5 shows the current through first switches 412A-412C, plot 504 shows current through second switches 414A-414D, while plot 505 shows current through inductor L_{osc}. As shown in plot 505, as converter 400 is operated to alternatingly switch between first switches 412A-412C and second switches 414A-414D, a current through inductor component L_{osc} 422 periodically rises and falls with each switching cycle. According to the techniques described herein, as shown in plots 503 and 504, first and second switches 412A-412C and 414A-414D are operated in accordance with the resonant behavior of inductor Losc 422 and/or Cfly capacitors 416A, C_{fly2} 416B such that the first switches 412A-412C are closed (and second switches 414A-414D are opened) when a current through second switches 414A-414D is zero or close to zero Likewise, second switches 414A-414D are closed (and first switches 412A-412C are opened) when a current through first switches 412A-412C is zero or close to zero.

According to the techniques herein, converter 400 is controlled based on one or more characteristics of fly capacitors 416A, 416B and/or inductor component Losc 422. For example, a controller 130 (not shown in FIG. 4), may control switches 412A-412C and 414A-414D with a switching frequency and/or a duty cycle based on a capacitance value of fly capacitors 416A, 416B, and/or an inductance of inductor component L_{osc} 422.

As one example, controller 130 may control converter 400 with a switching frequency F_{sw} according to the following equation:

$$Fsw = \frac{1}{N \times π \times \sqrt{\frac{Cfly \times Losc}{N - 1}}} \qquad ( 3 )$$

Wherein N=3 according to converter 400, and where C_{fly} is a capacitance value of capacitor C_{fly1} 416A, and C_{fly2} 416B, which have substantially equal capacitance values.

As shown in the above equation, a switching frequency F_{sw} may be determined based on an inductance of inductor component L_{osc} 408, a capacitance of fly capacitors C_{fly} 416A, 416B, and the conversion ratio N of controller 400 (N=3).

Controller 130 may also control a duty cycle of converter 400 according to equation (4) below:

$$Duty Cycle = \frac{Ton ( S 1 , S 4 , S 7 )}{T ( = 1 / Fsw )} = \frac{1}{N} \qquad ( 4 )$$

Where N =3 for controller 400. By controlling resonant switched capacitor converter 400 according to equations (3) and (4) above, converter 400 may operate with zero current switching (ZCS) where switches 412A-412C and 414A-414D are alternately switched on and off at times where little or no current is flowing through the respective switches. By operating according to equations (3) and (4) above, converter 400 may operate with greater efficiency in comparison to other DCDC converters, including typical switched capacitor network-based DCDC converters.

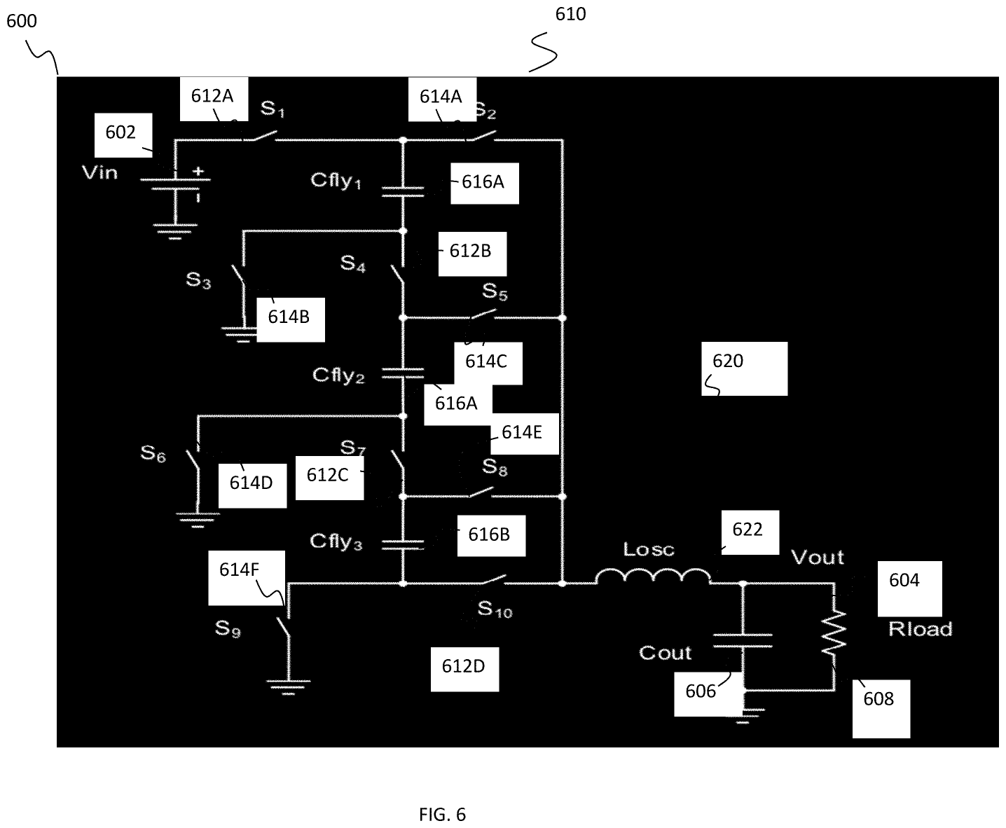

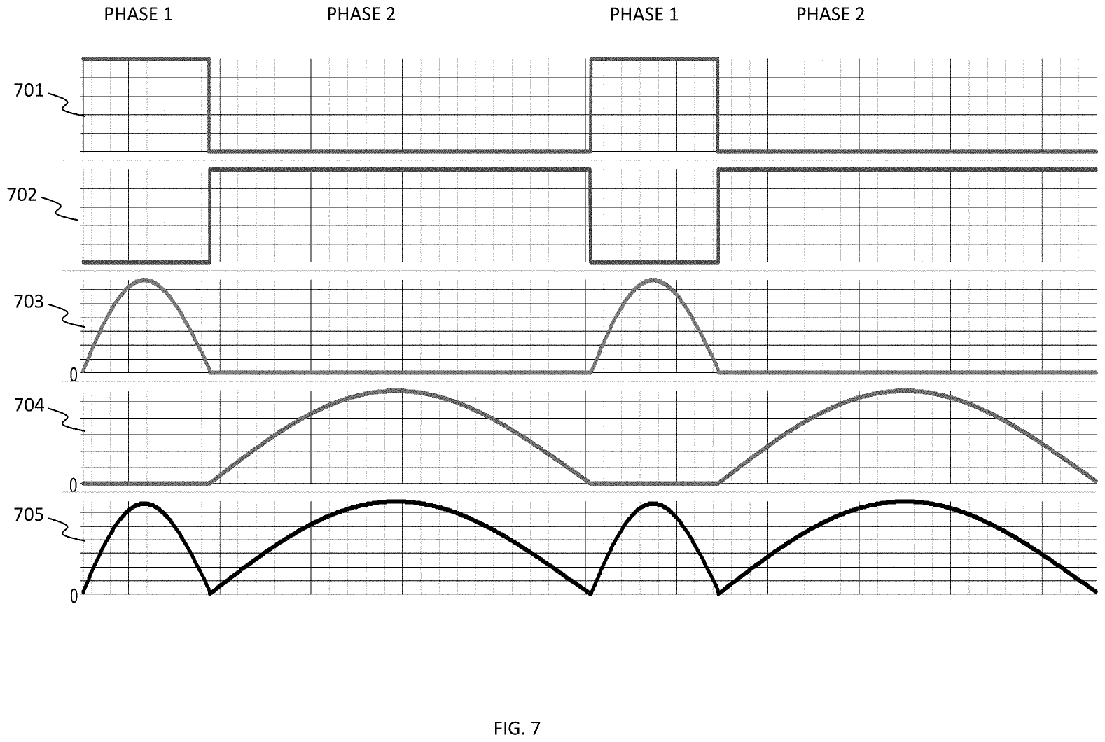

FIG. 6 is a circuit diagram that depicts one example of a resonant switched capacitor DCDC converter 600 with a conversion ratio of N=4 consistent with one or more aspects of this disclosure. FIG. 7 is a graphical diagram including plots depicting converter 600 in operation consistent with one or more aspects of this disclosure.

In the example depicted in FIG. 6, converter 600 includes an input Vᵢₙ 602 and an output Vₒᵤₜ 604. In the depicted example, converter 600 is a step-down converter configured to receive a higher DC voltage level at input Vᵢₙ 602, and convert it to a lower DC voltage level (Vᵢₙ/4) at output Vₒᵤₜ 604. In other examples not depicted in FIG. 6, converter 600 is configurable as a step-up converter by coupling a lower input voltage to Vₒᵤₜ 604, to convert it to a higher output voltage at Vᵢₙ 602.

In the example of FIG. 6, converter 600 includes an output capacitor Cₒᵤₜ 606 coupled to output Vₒᵤₜ 604, and a load resistance R_{load} 608 coupled to output Vₒᵤₜ 604. The load resistance R_{load} represents a resistance of a load to be powered by converter 600, such as an electronic component.

As shown in FIG. 6, converter 600 includes a capacitor network 610 and a resonance network 620. Capacitor network 610 includes a plurality of capacitors (first capacitor C_{fly1} 616A, second capacitor C_{fly2} 616B, third capacitor C_{fly3} 616C) a first group of switches (S1, S4, S7, S10) 612A-612D, and a second group of switches (S2, S3, S5, S6, S8, S9) 614A-614F. Resonance network 620 includes an inductor component L_{osc} 622 coupled between capacitor network 610 and output Vₒᵤₜ 604.

Converter 600 is controllable via the first group of switches 612A-612D and the second group of switches 614A-614F. For example, a controller 130 (not depicted in FIG. 6) may drive first switches 612A-612D in an alternating fashion with second switches 614A-614F, such that when first switches 612A-612D are closed, second switches 614A-614F are open, and vice versa.

Plot 701 of FIG. 7 depicts switching behavior of first switches 612A-612D (this group of switches are on when a voltage level of the signal shown on plot 701 is high), while plot 702 depicts switching behavior of second switches 614A-614F during operation of converter 600. As shown in plots 701 and 702, during a first phrase of converter 600, switches 612A (S1), 612B (S4), 612C (S7), and 612D (S10) are closed and switches 614A (S2), 614B (S3), 614C (S5), 614D (S8), 614E (S9), and 614F (S6) are open, transferring energy from input Vᵢₙ 602 to capacitors C_{fly1} 616A, C_{fly2} 616B, C_{fly3} 616C, and Cout 606, thereby charging capacitors 616A-616C. During the first phase of converter 600, capacitors 616A-616C may be described as connected in series with output capacitor Cₒᵤₜ 606.

As shown in plots 701 and 702, during a second phase of converter 600, first switches 612A (S1), 612B (S4), 612C (S7), and 612D (S10) are open and second switches 614A (S2), 614B (S3), 614C (S5), 614D (S8), 614E (S9), and 614F (S6) are closed, causing charge stored in capacitors 616A-616C to be discharged to output capacitor Cₒᵤₜ 606. During the second phrase of converter 600, capacitors 616A-616C may be described as connected in parallel with output capacitor Cₒᵤₜ 606.

Via switches 612A-612D and 614A-614F, converter 600 is controllable to provide power to an electronic component represented by the resistance R_{load} 608 with an output voltage Vₒᵤₜ that is “stepped down” relative to the input voltage Vᵢₙ by the ratio N=4. As shown in FIG. 6, a number of fly capacitors (C_{fly1} 616A, C_{fly2} 616B, C_{fly3} 616C) of converter 600 is equal to N−1=3.

According to converter 600 described herein, resonance network 620 introduces a resonance with which converter 600 may be operated to perform soft switching, thereby improving an efficiency of converter 600. Plot 703 of FIG. 7 shows the current through first switches 612A-612D, plot 704 shows current through second switches 614A-614F, while plot 705 shows current through inductor L_{osc}. As shown in plot 705, as converter 600 is operated to alternatingly switch between first switches 612A-612D and second switches 614A-614F, a current through inductor component Losc 622 periodically rises and falls with each switching cycle. According to the techniques described herein, as shown in plots 703 and 704, first and second switches 612A-612D and 614A-614F are operated in accordance with the resonant behavior of inductor L_{osc} 622 such that the first switches 612A-612D are closed (and second switches 614A-614F are opened) when a current through second switches 614A-614F is zero or close to zero Likewise, second switches 614A-614F are closed (and first switches 612A-612D are opened) when a current through first switches 612A-612D is zero or close to zero.

According to the techniques described herein, converter 600 is controlled based on one or more characteristics of fly capacitors 616A-616C and/or inductor component L_{osc} 622. For example, a controller 130 (not shown in FIG. 6), may control switches 612A-612D and 614A-614F with a switching frequency and/or a duty cycle based on a capacitance value of fly capacitors 616A-616C, and/or an inductance of inductor component L_{osc} 622.

As one example, controller 130 may control converter 600 with a switching frequency F_{sw} according to the following equation:

$$Fsw = \frac{1}{N \times π \times \sqrt{\frac{Cfly \times Losc}{N - 1}}} \qquad ( 5 )$$

Wherein N=4 according to converter 600, and where C_{fly} is a capacitance value of capacitors 616A-616C, which have substantially equal capacitance values.

As shown in the above equation, a switching frequency F_{sw} is determined based on an inductance of inductor component L_{osc} 622, a capacitance of fly capacitors C_{fly} 616A-616C and the conversion ratio N of controller 600 (N=4).

Controller 130 may also control a duty cycle of converter 600 according to equation (6) below:

$$Duty Cycle = \frac{Ton ( S 1 , S 4 , S 7 , S 10 )}{T ( = 1 / Fsw )} = \frac{1}{N} \qquad ( 6 )$$

Where N=4 for converter 600. By controlling resonant switched capacitor converter 600 according to equations (5) and (6) above, converter 600 may operate with zero current switching (ZCS) where switches 612A-612D and 614A-614F are alternately switched on and off at times where little or no current is flowing through the respective switches. By operating according to equations (5) and (6) above, converter 600 may operate with greater efficiency in comparison to other DCDC converters, including typical switched capacitor network-based DCDC converters.

Converter 600 has been built and tested, and has exhibited significant performance improvements in comparison with other types of power converters, such as a switched-capacitor network converter. For example, testing of converter 600 has demonstrated efficiency of 97%.

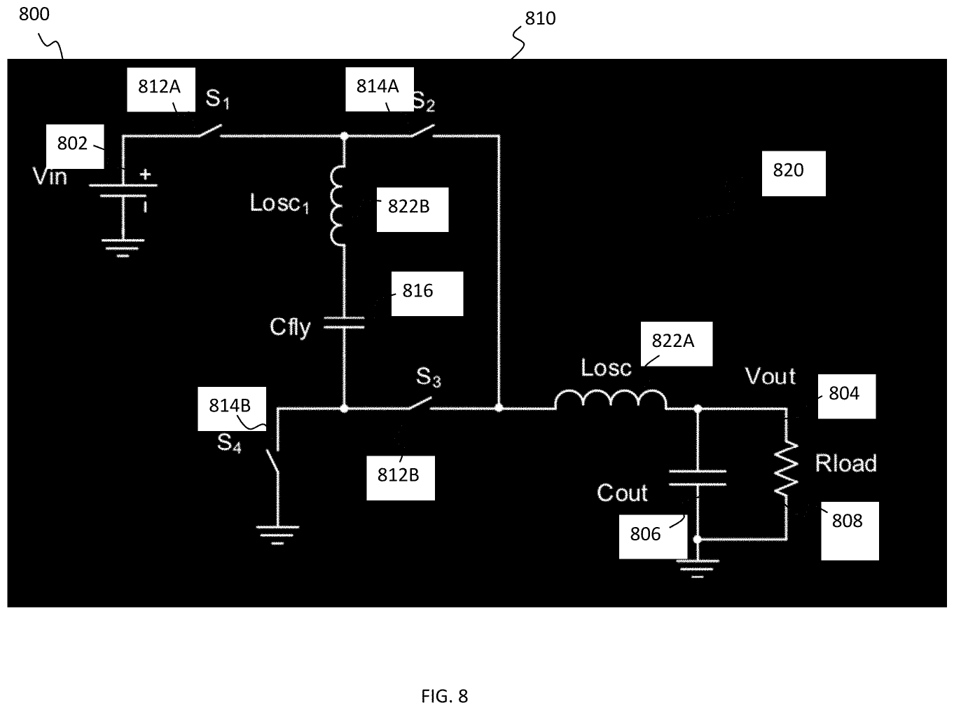

The examples of FIGS. 2-7 depict converter circuitry with a resonance network that includes only a single inductive component. One of ordinary skill in the art will readily recognize that a converter as described herein may be constructed using more than a single inductive component. One of skill in the art will further recognize that the circuitry and techniques described herein may be built and used with multiple inductive components in different configurations. FIGS. 8-10, 12A-12B, and 13A-13D below depicted various such examples, with multiple inductive elements. The multiple inductive elements of the respective resonance networks depicted in FIGS. 8-10, 12A-12B, and 13A-13D may include physical inductor components, or stray or parasitic inductances caused by interaction of other circuit components (e.g., wires, traces, PCB inductance).

FIG. 8 is a circuit diagram depicting another example of a converter 800 with a conversion ratio of N=2 consistent with one or more aspects of this disclosure. As shown in FIG. 8, like converter 200 depicted in FIG. 2, converter 800 includes a capacitor network 810 and a resonance network 820. However, unlike converter 200 depicted in FIG. 2, converter 800 includes a resonance network 820 with a plurality of inductor components, L_{osc} 822A and L_{osc} 822B. L_{osc} 822A is coupled to an output of converter 800, while L_{osc} 822B is coupled between capacitor C_{fly} 816, and switches 812A (S1) and 814A (S2).

Like converter 200 depicted in FIG. 8, converter 800 depicted in FIG. 8 is controllable to achieve soft switching (e.g., Zero Current Switching (ZCS)) based on one or more characteristics of a capacitor 816 of a capacitor network 810 and/or an inductor components 822A, 822B of resonance network 820. For example, a controller may control converter 800 with a switching frequency F_{sw} according to the following equation:

$$Fsw = \frac{1}{2 \times π \times \sqrt{\frac{Cfly \times ( Losc + Losc 1 )}{1}}} \qquad ( 7 )$$

In some examples, converter 800 may be operated with a duty cycle of 1/N =½.

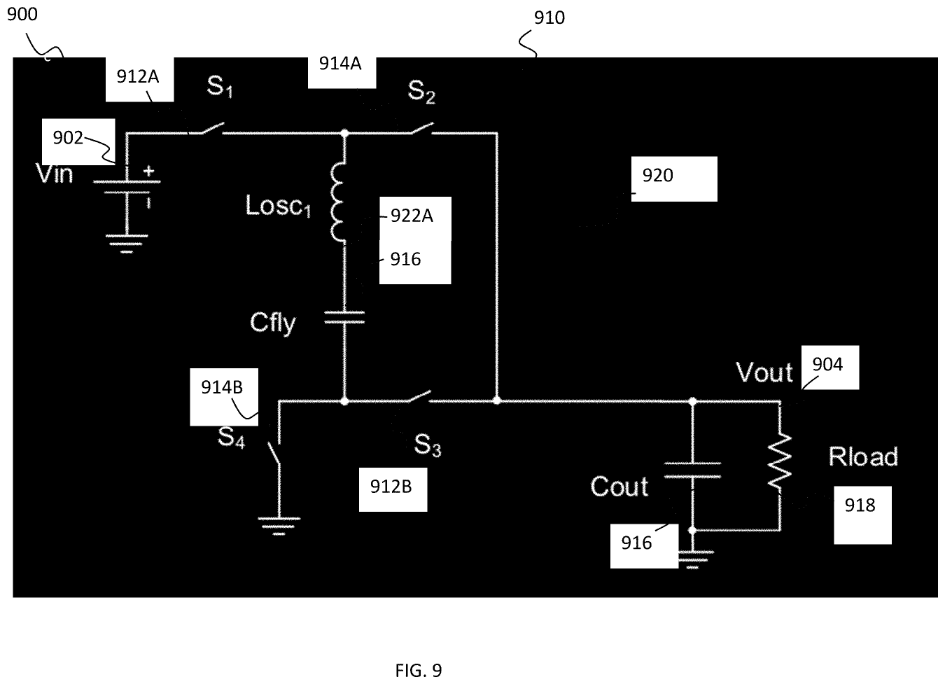

FIG. 9 is a circuit diagram depicting another example of a converter 900 with a conversion ratio N=2 consistent with one or more aspects of this disclosure. As shown in FIG. 9, like converter 200 depicted in FIG. 2, converter 900 includes a capacitor network 910 and a resonance network 920. However, unlike converter 200 depicted in FIG. 2, converter 900 includes a resonance network 820 with an inductor component L_{osc} 922A coupled between capacitor C_{fly} 916, and switches 912A (S1) and 914A (S2). As shown in FIG. 9, resonance network 910 of converter 900 does not include any inductor component coupled to an output 904 of converter 900.

Like converter 200 depicted in FIG. 2, converter 900 depicted in FIG. 9 is controllable to achieve soft switching (e.g., Zero Current Switching) based on one or more characteristics of a capacitor 916 of a capacitor network 910 and/or an inductor component 922A of resonance network 920. For example, a controller may control converter 900 with a switching frequency F_{sw} according to the following equation:

$$Fsw = \frac{1}{2 \times π \times \sqrt{\frac{Cfly \times ( Losc 1 )}{1}}} \qquad ( 8 )$$

In some examples, converter 900 may be operated with a duty cycle of 1/N =1/2.

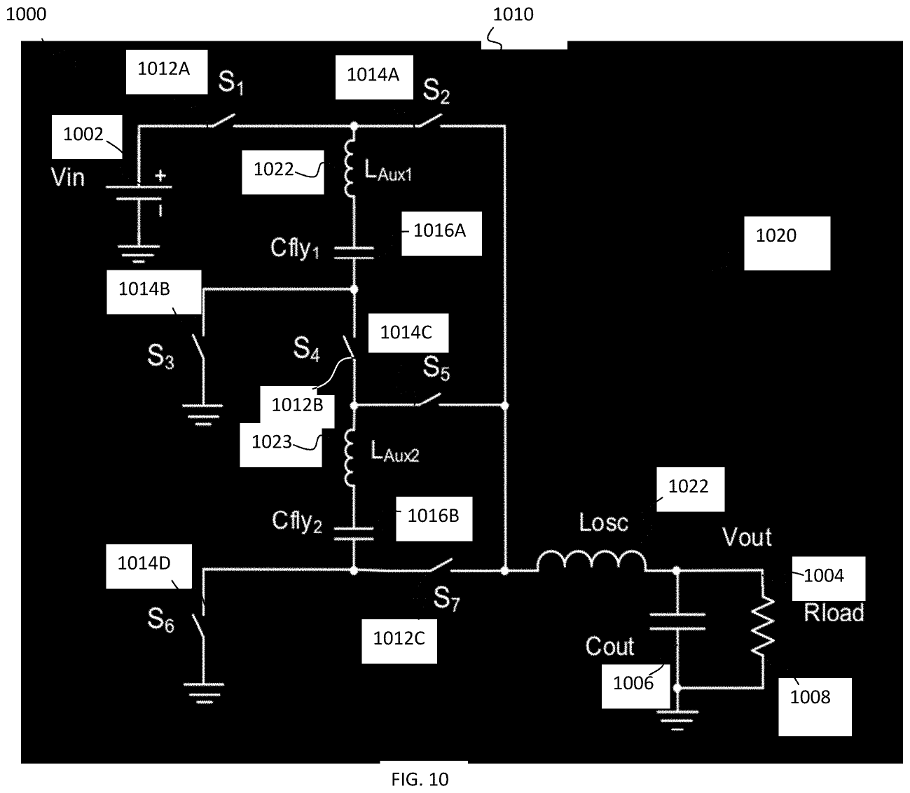

FIG. 10 is a circuit diagram depicting another example of a converter 1000 with a conversion ratio of N=3 consistent with one or more aspects of this disclosure. As shown in FIG. 10, like converter 400 depicted in FIG. 4, converter 1000 includes a capacitor network 1010 and a resonance network 1020. However, unlike converter 400 depicted in FIG. 4, converter 1000 includes a resonance network 1020 with a plurality of inductor components L_{osc} 1022, Lₐᵤₓ₁ 1023, and Lₐᵤₓ₂ 1024. As shown in FIG. 10, inductor component L_{osc} 1022 is coupled to output capacitor Cₒᵤₜ 1016 and load resistance R_{load} 1018, inductor component Lₐᵤₓ₁ 1023 is coupled between switch S1 1012A, switch S2 1014A, and capacitor C_{fly1} 1016A, while inductor component Lₐᵤₓ₂ 1024 is coupled between switch S4 1012B, switch S5 1014B, and capacitor Cfly2 1016B.

Like converter 400 depicted in FIG. 4, converter 1000 depicted in FIG. 10 is controllable to achieve soft switching (e.g., Zero Current Switching) based on one or more characteristics of a capacitor 1016A, 1016B of a capacitor network 1020 and/or an inductor component 1022, 1023, 1024 of resonance network 1020. For example, a controller may control converter 1000 with a switching frequency F_{sw} according to the following equation. In some examples, fly capacitors 1016A and 1016B are substantially similar (e.g., have substantially similar capacitance values). In some examples auxiliary inductors 1023 and 1024 are substantially similar (e.g., have substantially similar inductance values).

$${T}_{1} ( Duration of phase 1 ) = π \times \sqrt{\frac{Cfly}{2} \times ( {L}_{Aux 1} + {L}_{Aux 2} + Losc )}$$

$${T}_{2} ( Duration of phase 2 ) = π \times \sqrt{2 \times Cfly \times ( ( {L}_{Aux 1} ‖ {L}_{Aux 2} ) + Losc )}$$

$$Fsw = \frac{1}{{T}_{1} + {T}_{2}} DutyCycle = \frac{{T}_{1}}{{T}_{1} + {T}_{2}}$$

In some examples, L_{Aux1}=L_{Aux2}=L_{Aux}. According to such examples, the switching frequency and duty-cycle may be calculated as a function of the capacitor and inductors as:

$$Fsw = \frac{1}{π \times ( \sqrt{\frac{Cfly}{2} \times ( Losc + 2 \cdot {L}_{Aux} )} + \sqrt{2 \cdot Cfly \times ( Losc + \frac{{L}_{Aux}}{2} )} )}$$

$$and$$

$$DutyCycle = \frac{\sqrt{\frac{Losc}{2} + {L}_{Aux}}}{\sqrt{\frac{Losc}{2} + {L}_{Aux}} + \sqrt{2 \cdot Losc + {L}_{Aux}}}$$

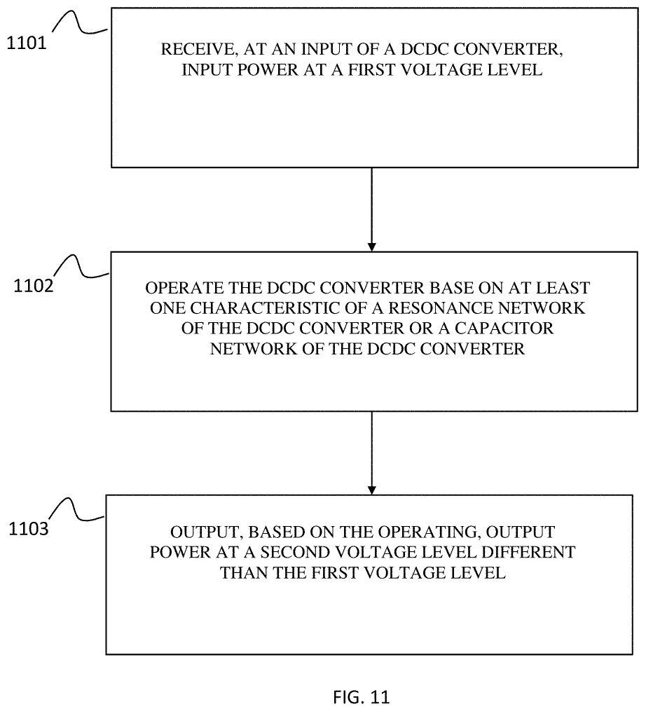

FIG. 11 is a flow diagram that depicts one example of a method of operating a DCDC converter (100) consistent with one or more aspects of this disclosure. As shown in FIG. 11, at 1101, the method includes receiving, at an input (102) of the DCDC converter, input power at a first voltage level. As also shown in FIG. 11, at 1102, the method further includes operating the DCDC converter based on at least one characteristic of a capacitor network (110) and/or a resonance network (120) of the DCDC converter. In some examples, operating the DCDC converter based on at least one characteristic of the capacitor network and/or the resonance network includes operating the DCDC converter with a switching frequency (F_{sw}) based on a capacitance value of at least one capacitor element of the capacitor network and/or an inductance value of at least one inductor component of the resonance network. As also shown in FIG. 11, the method further includes outputting, at an output (103) of the DCDC converter, output power at a second voltage level different than the first voltage level.

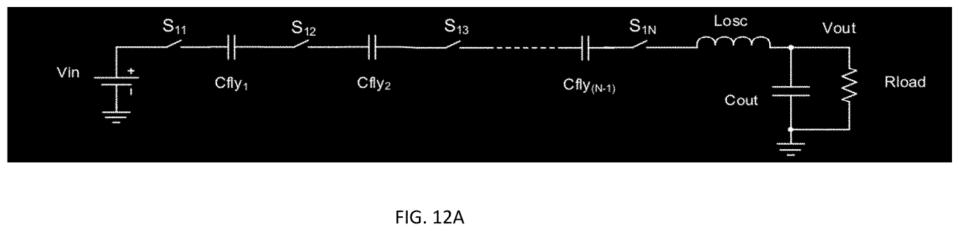

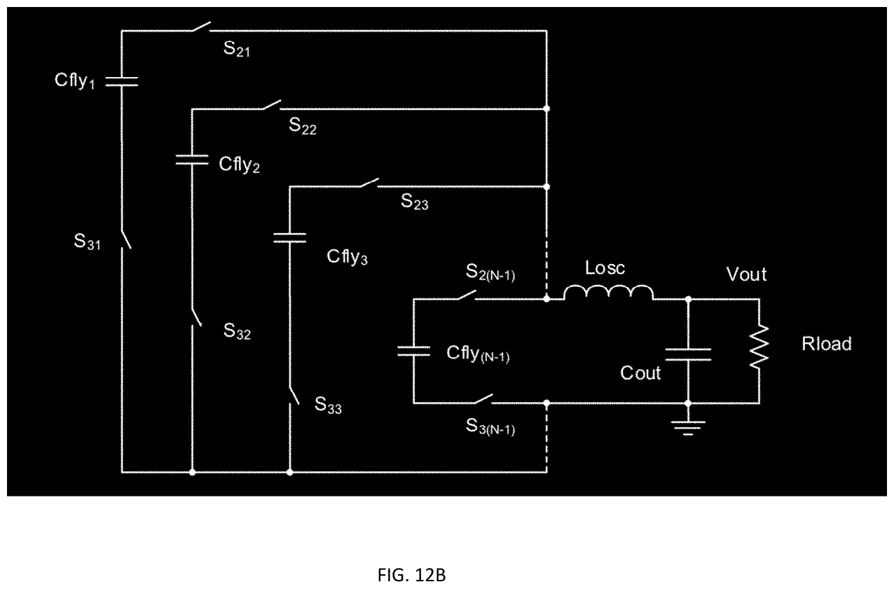

FIGS. 12A and 12B are conceptual diagrams that depict a generalized converter circuit adaptable to any desired conversion ratio, consistent with one or more aspects of this disclosure. In some examples, a converter 100 with conversion ratio of N includes a capacitor network with N−1 equal fly capacitors and 3N−2 switches, and a resonance network with and at least one inductor component represented by L_{osc} in FIGS. 12A and 12B. As depicted in FIG. 12A, during phase1, the first group of switches, including N switches, connect “N−1” fly capacitors in series with each other and to Vin and to the resonance network (e.g., including inductor L_{osc}). L_{osc} is coupled to Cout and the fly capacitors. Cout and L_{osc} are connected in series and coupled to Vin. If the converter is controlled with a switching frequency and duty cycle as described herein, then the charging current starts from zero (or near zero) and, after charging the entire capacitor string, is terminated at zero (or near zero) by the end of phase1. During phase1, some electrical charge is also delivered to Cₒᵤₜ and hence Cₒᵤₜ is charged.

As depicted in FIG. 12B, during phase2, the second group of switches, comprised of 2*(N−1) switches, connect the “N−1” fly capacitors in parallel and the resultant parallel combination is connected to the inductor component. During phase2 at least part of the energy stored in fly capacitors is transferred to Cout. If the converter is controlled with a switching frequency and duty cycle as described herein, the current of all switches in phase2 start from zero (or near zero) and is terminated at zero (or near zero). Hence zero current switching (ZCS) may be achieved during phase2 as well. Because the depicted converter operates with soft switching (ZCS) during phase1 and phase2 of the switching cycle, the efficiency of the converter may be greatly improved compared to other type of converters such as conventional switched capacitor converters.

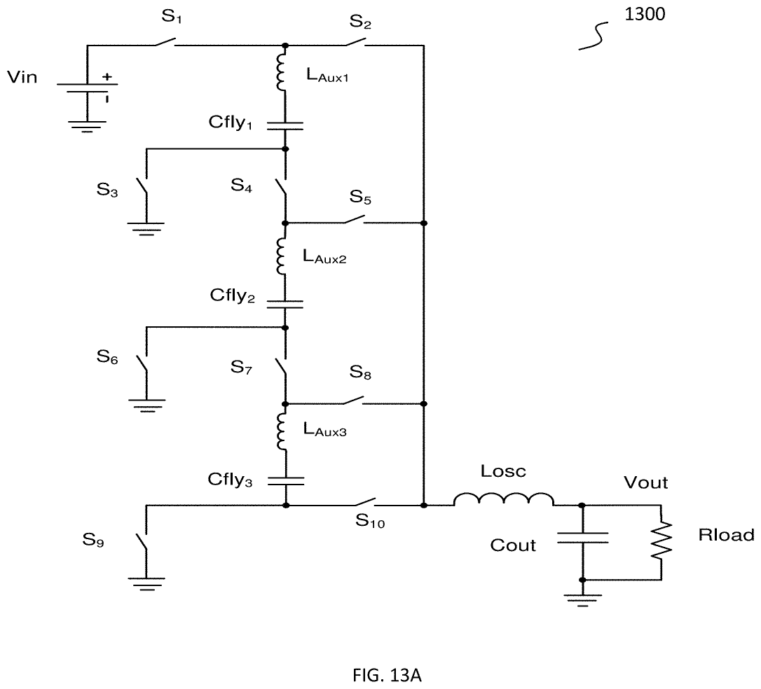

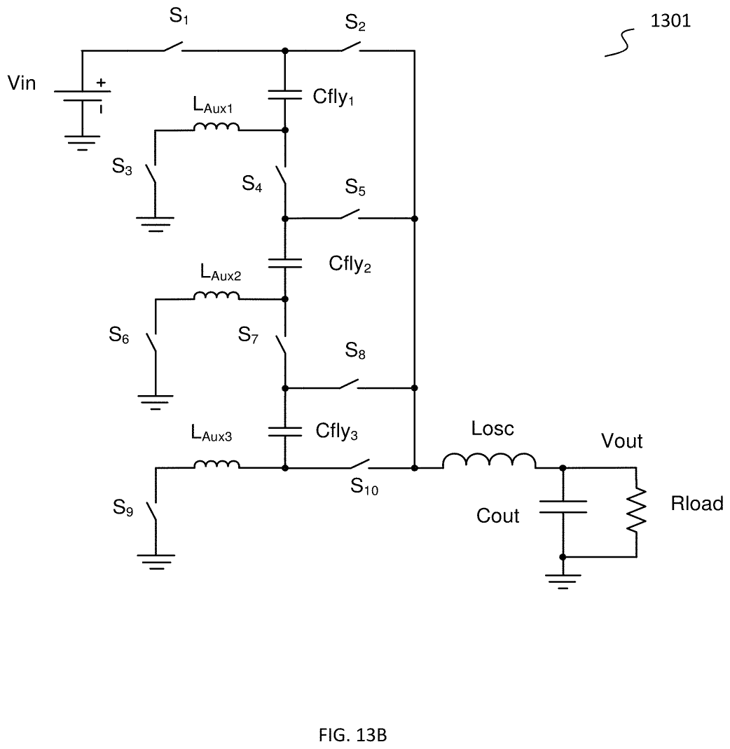

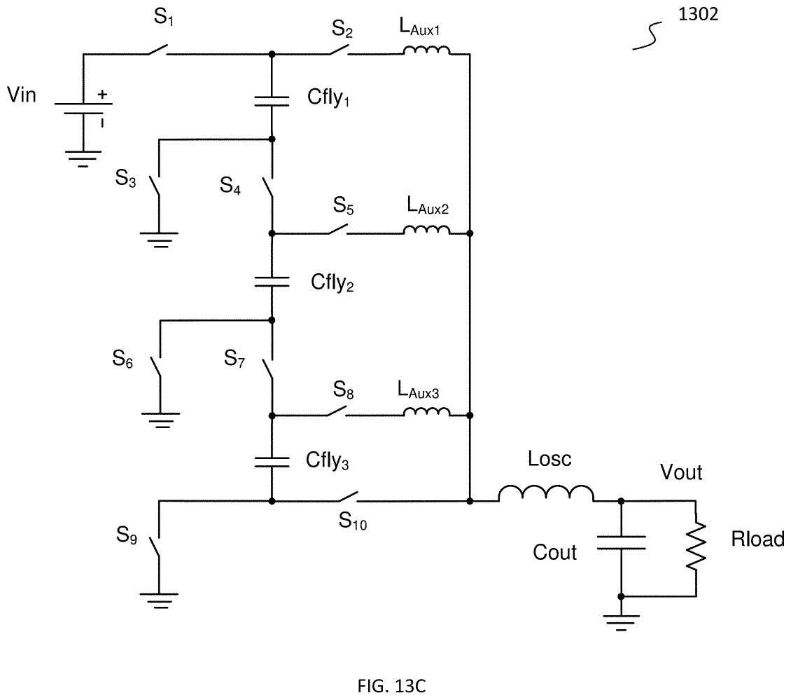

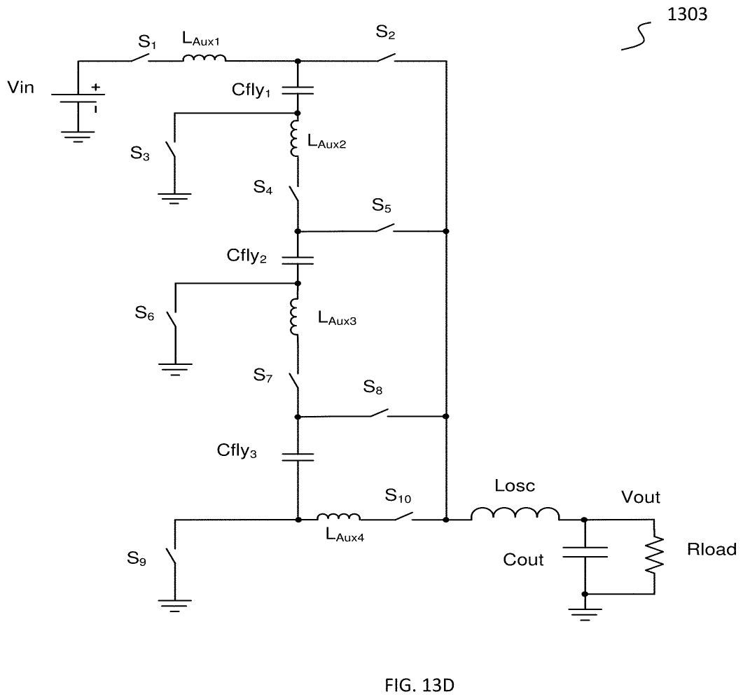

FIGS. 13A-13D are circuit diagrams that depict various examples of converters with an N=4 conversion ratio consistent with one or more aspects of this disclosure. As shown, each of FIGS. 13A-13D include examples with a resonant network that includes multiple inductances represented by L_{auxN}. In some examples, each of the depicted inductances L_{auxN} includes an inductor component with an inductance value that is a discrete element in the circuit. In other examples, one or more of the multiple inductances L_{auxN} depicted in FIGS. 13A-13D may instead include parasitic inductances caused by the interaction of other components of a device including the depicted converters.

Although FIGS. 13A-13D each depict examples where each respective converter includes an inductor component Losc coupled to an output of the converter, in other examples not depicted in FIGS. 13A-13D, each respective converter may not include an inductor component L_{osc}. In some such examples, the inductance L_{osc} shown in FIGS. 13A-13D may represent a parasitic inductance, not an inductor component.

FIG. 13A is a circuit diagram depicting one example of a converter with an N=4 conversion ratio that includes multiple inductances. As shown in the example of FIG. 13A, a resonance network of converter 1300 includes an inductor component L_{osc} coupled to an output of the converter Vₒᵤₜ. In addition, the resonance network of converter 1300 includes a plurality of auxiliary inductances L_{Aux1}, L_{Aux2}, and L_{Aux3}, L_{Aux1}, L_{Aux2}, and L_{Aux3} may each be substantially similar to one another, for example they may each have a substantially similar inductance value.

As depicted in FIG. 13A, inductance Lₐᵤₓ₁ is coupled between switches S1 and S2, and capacitor Cfly1, inductance Lₐᵤₓ₂ is coupled between switches S4, S5, and capacitor Cfly2, and inductance Lₐᵤₓ₃ is coupled between switches S7, S8, and capacitor Cfly3.

During phase1 switches S₁, S₄, S₇, and S₁₀ are on and the auxiliary inductors and fly capacitors, Losc and Cout are in series. The series combination is connected to Vin. Fly capacitors C_{fly} are charged through a resonance action and energy is transferred from Vin to the fly capacitors and Cout.

During phase2 switches S₁, S₄, S₇, and S ₁₀ are off and the remaining switches are on. Each fly capacitor C_{fly} is connected in series with one of the auxiliary inductors and the pair is connected in parallel with the other two pairs of “Cfly+L_{Aux}”. The combination of three pairs are connected to Losc which is in series with Cout. During phase2, some of the charge stored in fly capacitors is transferred to Cout through a resonance action.

In some examples, converter 1300 depicted in FIG. 13A may be controlled with a switching frequency defined by the following equation, assuming Lₐᵤₓ is the average of the three auxiliary inductors

$$( {L}_{aux} = \frac{{L}_{Aux 1} + {L}_{Aux 2} + {L}_{Aux 3}}{3} ) : \\ Fsw = \frac{1}{π \times ( \sqrt{Cfly \times ( 3 \cdot Losc + {L}_{aux} )} + \sqrt{Cfly \times ( \frac{Losc}{3} + {L}_{aux} )} )}$$

In some examples, converter 1300 depicted in FIG. 13A may be controlled with a duty cycle defined by the following equation:

$$Duty\_Cycle = \frac{Ton ( {S}_{1} , {S}_{4} , {S}_{7} , {S}_{10} )}{T ( = \frac{1}{Fsw} )} = \frac{\sqrt{\frac{Losc}{3} + {L}_{aux}}}{\sqrt{3 \cdot Losc + {L}_{aux}} + \sqrt{\frac{Losc}{3} + {L}_{aux}}}$$

FIG. 13B is a circuit diagram depicting one example of a converter with an N=4 conversion ratio that includes multiple inductances. As shown in the example of FIG. 13A, a resonance network of converter 1301 includes an inductor component L_{osc} coupled to an output of the converter Vₒᵤₜ. In addition, the resonance network of converter 1301 includes a plurality of auxiliary inductances Lₐᵤₓ₁, Lₐᵤₓ₂, and Lₐᵤₓ₃. Lₐᵤₓ₁, Lₐᵤₓ₂, and Lₐᵤₓ₃ may each be substantially similar to one another, for example they may each have a substantially similar inductance value. As depicted in FIG. 13B, inductance Lₐᵤₓ₁ is coupled between capacitor C_{fly1} and switches S3 and S4, inductance Lₐᵤₓ₂ is coupled between capacitor C_{fly2} and switches S6 and S7, and inductance Lₐᵤₓ₃ is coupled between capacitor C_{fly3} and switches S9 and S10.

During phase1 switches S₁, S₄, S₇, and S₁₀ are on and the fly capacitors, Losc and Cout are in series. The series combination is connected to Vin. Fly capacitors are charged through a resonance action and energy is transferred from Vin to fly capacitors and Cout.

During phase2 switches S₁, S₄, S₇, and S₁₀ are off, the the remaining switches are on. Each fly capacitor is connected in series with one of the auxiliary inductors L_{auxN} and the pair is connected in parallel with the other two pairs of “Cfly+L_{Aux}”. The combination of three pairs are connected to Losc which is in series with Cout. During phase2, some of the charge stored in fly capacitors is transferred to Cout through a resonance action.

In some examples, converter 1301 depicted in FIG. 13B may be controlled with a switching frequency defined by the following equation assuming Lₐᵤₓ is the average of the three auxiliary inductors

$$( {L}_{aux} = \frac{{L}_{Aux 1} + {L}_{Aux 2} + {L}_{Aux 3}}{3} ) : \\ Fsw = \frac{1}{π \times ( \sqrt{Cfly \times ( 3 \cdot Losc + {L}_{aux} )} + \sqrt{Cfly \times \frac{Losc}{3}} )}$$

In some examples, converter 1301 depicted in FIG. 13B may be controlled with a duty cycle defined by the following equation:

$$Duty\_Cycle = \frac{\sqrt{Losc}}{\sqrt{9 \cdot Losc + 3 \cdot {L}_{aux}} + \sqrt{Losc}}$$

FIG. 13C is a circuit diagram depicting one example of a converter with an N=4 conversion ratio that includes multiple inductances. As shown in the example of FIG. 13C, a resonance network of converter 1302 includes an inductor component L_{osc} coupled to an output of the converter Vₒᵤₜ. In addition, the resonance network of converter 1302 includes a plurality of auxiliary inductances Lₐᵤₓ₁, Lₐᵤₓ₂, and Lₐᵤₓ3. Lₐᵤₓ₁, Lₐᵤₓ₂, and Lₐᵤₓ₃ may each be substantially similar to one another, for example they may each have a substantially similar inductance value. As depicted in FIG. 13C, inductance Lₐᵤₓ₁ is coupled between switch S2 and inductance L_{osc}, inductance Lₐᵤₓ₂ is coupled between switch S5 and inductance L_{osc}, and inductance Lₐᵤₓ₃ is coupled between switch S8 and inductance L_{osc}.

During phase1 switches S₁, S₄, S₇, and S₁₀ are on, the fly capacitors, Losc and Cout are in series. The series combination is connected to Vin. Fly capacitors are charged through a resonance action and energy is transferred from Vin to fly capacitors and Cout.

During phase2 switches S₁, S₄, S₇, and S₁₀ are off, the remaining switches are on. Each fly capacitor is connected in series with one of the auxiliary inductors and the pair is connected in parallel with the other two pairs of “Cfly+L_{Aux}”. The combination of three pairs are connected to Losc which is in series with Cout. During phase2, some of the charge stored in fly capacitors is transferred to Cout through a resonance action.

In some examples, converter 1302 depicted in FIG. 13C may be controlled with a switching frequency defined by the following equation assuming Lₐᵤₓ is the average of the three auxiliary inductors

$$( {L}_{aux} = \frac{{L}_{Aux 1} + {L}_{Aux 2} + {L}_{Aux 3}}{3} ) : \\ Fsw = \frac{1}{π \times ( \sqrt{Cfly \times ( 3 \cdot Losc + {L}_{aux} )} + \sqrt{Cfly \times \frac{Losc}{3}} )}$$

In some examples, converter 1302 depicted in FIG. 13C may be controlled with a duty cycle defined by the following equation:

$$Duty\_Cycle = \frac{\sqrt{Losc}}{\sqrt{9 \cdot Losc + 3 \cdot {L}_{aux}} + \sqrt{Losc}}$$

FIG. 13D is a circuit diagram depicting one example of a converter with an N=4 conversion ratio that includes multiple inductances. As shown in the example of FIG. 13D, a resonance network of converter 1303 includes an inductor component L_{osc} coupled to an output of the converter Vₒᵤₜ. In addition, the resonance network of converter 1303 includes a plurality of auxiliary inductances Lₐᵤₓ₁, Lₐᵤₓ₂, Lₐᵤₓ₃, and Lₐᵤₓ₄. Lₐᵤₓ₁, Lₐᵤₓ₂, Lₐᵤₓ₃, and Lₐᵤₓ₄ may each be substantially similar to one another, for example they may each have a substantially similar inductance value. As depicted in FIG. 13D, inductance Lₐᵤₓ₁ is coupled between switch S1, switch S2, and capacitor C_{fly1}, inductance Lₐᵤₓ₂ is coupled between switch S3, switch S4, and capacitor C_{fly1}, inductance Lₐᵤₓ₃ is coupled between switch S6, switch S7, and capacitor C_{fly2}, and inductance Lₐᵤₓ₄ is coupled between switch S9, switch S10, and capacitor C_{fly3}.

During phase1 switches S₁, S₄, S₇, and S₁₀ are on, and the auxiliary inductors and fly capacitors, Losc and Cout are in series. The series combination is connected to Vin. Fly capacitors are charged through a resonance action and energy is transferred from Vin to fly capacitors and Cout.

During phase2 switches S₁, S₄, S₇, and S₁₀ are off, and the remaining switches are on. All the fly capacitor are connected in parallel, and the parallel combination is connected to Losc which is in series with Cout. During phase2, some of the charge stored in fly capacitors is transferred to Cout through a resonance action.

In some examples, converter 1303 depicted in FIG. 13D may be controlled with a switching frequency defined by the following equation assuming Lₐᵤₓ is the average of the four auxiliary inductors

$$( {L}_{aux} = \frac{{L}_{Aux 1} + {L}_{Aux 2} + {L}_{Aux 3} + {L}_{Aux 4}}{4} ) : \\ Fsw = \frac{1}{π \times ( \sqrt{3 \cdot Cfly \times Losc} + \sqrt{\frac{Cfly}{3} \times ( Losc + 4 \cdot {L}_{aux} )} )}$$

In some examples, converter 1303 depicted in FIG. 13D may be controlled with a duty cycle defined by the following equation:

$$Duty\_Cycle = \frac{\sqrt{Losc + 4 \cdot {L}_{aux}}}{3 \sqrt{Losc} + \sqrt{Losc + 4 \cdot {L}_{aux}}}$$

FIGS. 10, 12A-12B, and 13A-13D depict various examples of DCDC power converters with a capacitor network and a resonance network including a plurality of inductances, which may or may not comprise inductor components, consistent with one or more aspects of this disclosure. One of ordinary skill in the art will readily understand that these examples are intended to be non-limiting, and that a converter including a capacitor network and any arrangement of inductances relative to the capacitor network falls within the scope of this disclosure. One of ordinary skill in the art will further readily appreciate that the specific arrangements of inductances shown in FIGS. 13A-13D may be used together in the same circuit. As specific non-limiting examples, a converter as described herein may include a resonance network with the specific arrangement of auxiliary inductances L_{auxN} depicted in FIG. 13A to also include the auxiliary inductances arranged as shown in FIG. 13B, 13C, and/or 13D.

In some examples, it may be preferable for a resonant frequency of all paths of a converter as described herein to be substantially equal during phase 2. As discussed throughout this disclosure, a converter as described herein may be controlled based on one or more characteristics of a capacitor network and/or a resonance network (e.g., an inductance value of the resonance network). In some examples, where a converter includes a resonance network with a plurality of inductances, the converter may be controlled based on a mean value of the plurality of inductances. For example, a duty cycle and/or switching frequency used to control the converter may be based on a collective inductance value of the multiple inductances, divided by the number of inductances. For example, for a resonant network including three inductors Lₐᵤₓ₁, Lₐᵤₓ₂, Lₐᵤₓ₃, the switching frequency and/or duty cycle may be determined based on a mean inductance value of (Lₐᵤₓ₁+Lₐᵤₓ₂+Lₐᵤₓ₃)/3. According to one such example, each inductance of a resonance network may be substantially similar to other inductances of the resonance network. According to other examples, the inductance value of the respective inductors may be different, and the converter is controlled based on a mean inductance value determined as described above.

This disclosure is directed to DCDC power converters and techniques for controlling the described DCDC power converters to perform soft switching to improve converter efficiency. One of ordinary skill in the art will recognize that the control techniques described herein may be implemented using any combination of hardware, software, and/or firmware components capable of generating driving pulses to control the respective first and second groups switches of the described DCDC converter. For example, a controller configured to operate as described herein may be implemented largely in hardware, where one or more circuit components are coupled to generate controlling pulses which are controllable via hardware user inputs, such as a potentiometer. In other examples, a controller as described herein may be implemented via software instructions stored in a tangible medium, such as a memory or long-term storage component, which cause the computing device to generate pulses as described herein. In still other examples, a controller as described herein may be implemented via firmware, where a device such as a field programmable gate array (FPGA) is one or multiple-time programmable to generate pulses to control the respective first and second groups switches of the described DCDC converter according to the techniques described herein.

1. A direct current to direct current (DCDC) converter, comprising:
an input;
an output;
a capacitor network;
a resonance network coupled to the capacitor network; and
at least one controller operable to control the DCDC converter to perform soft switching based on at least one characteristic of the resonance network and/or the capacitor network.

2. The converter of claim 1, wherein the at least one controller is operable to control the DCDC converter based on an inductance associated with the resonance network and/or a capacitance associated with the capacitor network.

3. The converter of claim 2, wherein the inductance is an inductance value of at least one inductor component or the resonance network.

4. The converter of claim 1, wherein the DCDC converter is a single stage converter.

5. The converter of claim 2, wherein the capacitance is a capacitance value of at least one capacitor of the capacitor network.

6. The converter of claim 1, wherein the at least one controller is operable to control the DCDC converter to perform soft switching by determining a switching frequency and/or a duty cycle of the DCDC converter.

7. The converter of claim 6, wherein the at least one controller determines the switching frequency based on an inductance associated with the resonance network and/or a capacitance associated with the capacitor network.

8. The converter of claim 7, wherein the at least one controller is operable to control the switching frequency Fsw of the capacitor network based on the equation:
$$Fsw = \frac{1}{N \times π \times \sqrt{\frac{Cfly \times Losc}{N - 1}}}$$
wherein C_{fly} is a capacitance of at least one capacitor component of the capacitor network, L_{osc} is an inductance of at least one inductor component of the resonance network and N is a conversion ratio.

9. The converter of claim 6, wherein the controller determines the duty cycle of the DCDC converter based on a conversion ratio of the DCDC converter.

10. A method of operating a DCDC power converter, comprising:
receiving, at an input of the DCDC converter, input power at a first voltage level;
operating the DCDC converter based on at least one characteristic of a resonance network of the DCDC converter and/or a capacitor network of the DCDC converter, to perform soft switching; and
outputting, based on the operating, output power at a second voltage level different than the first voltage level.

11. The method of claim 10, further comprising:
operating the DCDC converter based on an inductance associated with the resonance network and/or a capacitance associated with the capacitor network.

12. The method of claim 11, wherein the inductance is an inductance value of at least one inductor component or the resonance network.

13. The method of claim 10, further comprising:
operating the DCDC converter based on resonant behavior of the resonance network and capacitor network.

14. The method of claim 11, wherein the capacitance is a capacitance value of at least one capacitor of the switched capacitor network.

15. The method of claim 10, further comprising:
operating the DCDC converter to perform soft switching by determining a switching frequency of the DCDC converter.

16. The method of claim 15, further comprising:
determining the switching frequency based on an inductance associated with the resonance network and/or a capacitance associated with the switched capacitor network.

17. The method of claim 16, further comprising:
determining the switching frequency F_{sw} of the switched capacitor network based on the equation:
$$Fsw = \frac{1}{N \times π \times \sqrt{\frac{Cfly \times Losc}{N - 1}}}$$
wherein C_{fly} is a capacitance of at least one capacitor component of the switched capacitor network, L_{osc} is an inductance of at least one inductor component of the resonance network and N is the conversion ratio.

18. The converter of claim 10, further comprising:
determining a duty cycle of the DCDC converter based on a conversion ratio of the DCDC converter.

19. A direct current to direct current (DCDC) converter, comprising:
an input;
an output;
a switched capacitor network;
a resonance network coupled to the switched capacitor network; and
means for controlling the DCDC converter to perform soft switching based on at least one characteristic of the resonance network and/or the switched capacitor network.

20. The DCDC converter of claim 17, wherein the means for controlling the DCDC converter control the DCDC converter based on an inductance associated with the resonance network.
